(19) United States
(12) Patent Application Publication
(10) Pub. No.: US 2021/0239936 A1
(43) Pub. Date: Aug. 5, 2021

(54) LENS APPARATUS AND IMAGE CAPTURING APPARATUS

(71) Applicant: VICTOR HASSELBLAD AB, Gotenborg (SE)

(72) Inventors: Masahiro SHIRONO, Tokyo (JP); Longji BAI, Tokyo (JP); Takashi KOYAMA, Tokyo (JP)

(21) Appl. No.: 17/237,033

(22) Filed: Apr. 21, 2021

(30) Foreign Application Priority Data
Apr. 23, 2020 (JP) 2020-076959

(51) Int. Cl. G02B 7/09; G03B 13/36; G02B 7/02; G02B 7/14

(52) U.S. Cl. CPC G02B 7/09; G02B 7/14; G02B 7/021; G03B 13/36

(57) ABSTRACT

A lens apparatus includes a barrel configured to accommodate a plurality of lenses, a first ring arranged around the barrel and configured to rotate about an optical axis, a second ring arranged around the first barrel and configured to rotate about the optical axis and move together with the first ring between a first position and a second position in an optical axis direction, a friction member arranged between surfaces of the first and second rings facing each other and configured to generate a frictional force on the second ring to cause the second ring to rotate together with the first ring when the first and second rings are in the first position, and a resistance member configured to generate a resistance force on the second ring to prevent the second ring from rotating together with the first ring when the first and second rings are in the second position.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION

This application claims priority to Japanese Patent Application No. 2020-076959, filed on Apr. 23, 2020, the entire content of which is incorporated herein by reference.

### TECHNICAL FIELD

The present disclosure relates to a lens apparatus and an image capturing apparatus.

### BACKGROUND

Patent Document 1 describes that “when the operation ring 17 is moved from the subject side position (first position) to the main body side position (second position), the substantially V-shaped portion follows the engaging pin 18b, turning the distance indicator wheel 18 slightly and thereby causing the engaging pin 18 and the engaging portion 17b to engage with each other smoothly.”

According to the structure described in Patent Document 1, when the operation ring 17 is moved from the subject side position (first position) to the main body side position (second position), the distance indicator wheel 18 is turned.

### [Patent Document 1] JP-A-2013-7906

### SUMMARY

To solve the above problems, a lens apparatus is provided. The lens apparatus according to an aspect of the present disclosure may comprise a first barrel for accommodating a plurality of lenses. The lens apparatus may comprise a first ring arranged around the first barrel such that the first ring can rotate about an optical axis. The lens apparatus may comprise a second ring arranged around the first barrel such that the second ring can rotate about the optical axis and can move together with the first ring between a first position and a second position in an optical axis direction. The lens apparatus may comprise a friction member arranged between the respective surfaces of the first ring and the second ring facing each other, and for generating a frictional force on the second ring that rotates the second ring together with the first ring in accordance with the rotation of the first ring when the first ring and the second ring are in the first position. The lens apparatus may comprise a resistance member for generating a resistance force on the second ring to prevent the second ring from rotating together with the first ring in accordance with the rotation of the first ring when the first ring and the second ring are in the second position.

The resistance member may comprise a first engagement member fixed to the second ring and a second engagement member held in the first barrel and engaging with the first engagement member when the first ring and the second ring are in the second position.

The first engagement member may comprise a plurality of first convex portions and the second engagement member comprises a plurality of second convex portions that engage with the plurality of first convex portions.

The second ring may cover part of the outer peripheral surface of the first ring. The friction member may be arranged between the part of the outer peripheral surface of the first ring and part of the inner peripheral surface of the second ring facing the part of the outer peripheral surface of the first ring.

The first ring may be an operation ring for receiving an operation of moving at least one of the plurality of lenses in the optical axis direction. The second ring may be a display ring for displaying an indicator corresponding to a rotation angle with respect to the first barrel.

The lens apparatus may comprise a circuit configured to control, on the basis of the rotation angle of the display ring with respect to the first barrel, a drive mechanism to move at least one of the plurality of lenses in the optical axis direction when the operation ring and the display ring are in the first position; and control, on the basis of a rotation amount and rotation direction of the operation ring, a drive mechanism to move at least one of the plurality of lenses in the optical axis direction when the operation ring and the display ring are in the second position.

The lens apparatus may comprise a second barrel for holding the plurality of lenses and arranged in the first barrel such that the second barrel can move in the optical axis direction together with the plurality of lenses between a third position where the photographable distance range is set to a first distance range and a fourth position where the photographable distance range is set to a second distance range. The lens apparatus may comprise a cam ring arranged around the first barrel such that the cam ring can rotate about the optical axis and comprising a cam groove that engages with a cam pin of the second barrel through a groove of the first barrel along the optical axis direction. The lens apparatus may comprise a switching ring arranged around the cam ring such that the switching ring can rotate about the optical axis together with the cam ring and for receiving an operation of switching the second barrel between the third position and the fourth position by means of the cam ring.

The resistance member may comprise a first engagement member fixed to the display ring. The resistance member may comprise a second engagement member held in the first barrel by being fixed to the cam ring, and engaging with the first engagement member when the operation ring and the display ring are in the second position.

The first engagement member may comprise a plurality of first convex portions. The second engagement member may comprise a plurality of second convex portions that engage with the plurality of first convex portions.

The lens apparatus may further comprise a cover ring arranged around the first barrel and for covering, when the operation ring and the display ring are in the second position, the outer peripheral surface of the display ring for displaying the indicator.

The image capturing apparatus according to an aspect of the present disclosure may comprise a lens apparatus and an image sensor for capturing an image formed through the plurality of lenses.

According to an aspect of the present disclosure, when the first ring and the second ring move to the first position or the second position in the optical axis direction, the rotation deviation of the second ring with respect to the first barrel can be suppressed.

Incidentally, the above summary of the disclosure does not enumerate all the necessary features of the present disclosure. In addition, sub-combinations of groups of features may also be disclosures.

### BRIEF DESCRIPTION OF THE DRAWINGS

FIG. 1 is an external perspective view of an image capturing apparatus according to the present disclosure.

FIG. 2 is a diagram showing an example of a functional block diagram of the image capturing apparatus according to the present disclosure.

FIG. 3 is a diagram showing a side view of the lens apparatus set to the full-time MF mode.

FIG. 4 is a diagram showing a side view of the lens apparatus set to the distance scale MF mode.

FIG. 5 is a cross-sectional perspective view of the lens apparatus in a state in which the operation ring and the display ring are moved to the image plane side position in the optical axis direction.

FIG. 6 is a cross-sectional perspective view of the lens apparatus in a state in which the operation ring and the display ring are moved to the subject side position in the optical axis direction.

FIG. 7 is an enlarged cross-sectional perspective view of a part including a friction member and a resistance member when the operation ring and the display ring are located in the image plane side position.

FIG. 8 is an enlarged cross-sectional perspective view of a part including the friction member and the resistance member when the operation ring and the display ring are in the subject side position.

FIG. 9 is a diagram showing a positional relationship of a rotation restraining member in a normal photographing mode.

FIG. 10 is a diagram showing the positional relationship of the rotation restraining member in a normal photographing mode.

FIG. 11 is a diagram showing the positional relationship of the rotation restraining member in a normal photographing mode.

FIG. 12 is a diagram showing the positional relationship of the rotation restraining member in a macro photographing mode.

FIG. 13 is a diagram showing the positional relationship of the rotation restraining member in a macro photographing mode.

FIG. 14 is a diagram showing the positional relationship of the rotation restraining member in a macro photographing mode.

FIG. 15 is a diagram showing a positional relationship of a potentiometer in the normal photographing mode.

FIG. 16 is a diagram showing the positional relationship of the potentiometer in the normal photographing mode.

FIG. 17 is a diagram showing the positional relationship of the potentiometer in the normal photographing mode.

FIG. 18 is a diagram showing the positional relationship of the potentiometer in the normal photographing mode.

FIG. 19 is a diagram showing the positional relationship of the potentiometer in the macro photographing mode.

FIG. 20 is a diagram showing the positional relationship of the potentiometer in the macro photographing mode.

FIG. 21 is a diagram showing the positional relationship of the potentiometer in the macro photographing mode.

FIG. 22 is a diagram showing the positional relationship of the potentiometer in the macro photographing mode.

FIG. 23 is a diagram for explaining the relationship between the circular arc length of a resistor and the circular arc length of the area of the distance scale of the display ring.

FIG. 24 is a diagram for explaining the relationship between the circular arc length of a resistor and the circular arc length of the area of the distance scale of the display ring.

### DESCRIPTION OF THE EMBODIMENTS

Hereinafter, the present disclosure will be explained through embodiments of the disclosure, but the following embodiments are not intended to limit the disclosure. In addition, all combinations of features explained in the embodiments are not necessarily indispensable for the solution means of the disclosure. It will be apparent to a person skilled in the art that various modifications or improvements can be made with regard to the following embodiments. It is apparent that embodiments with such modifications or improvements can be included in the technical scope of the present disclosure.

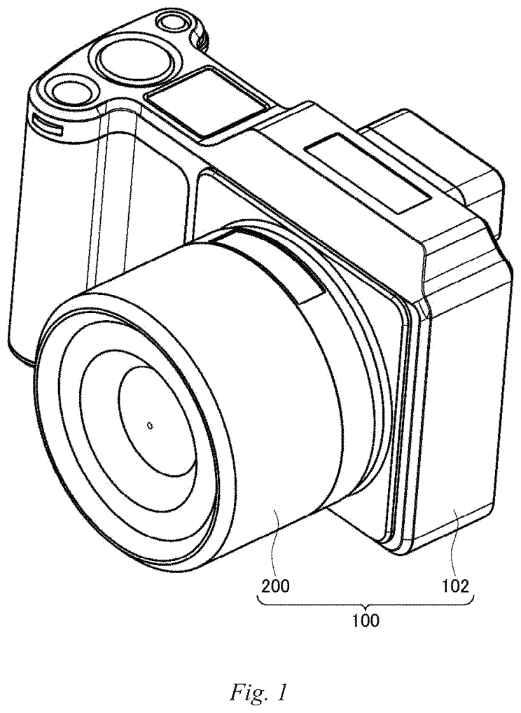

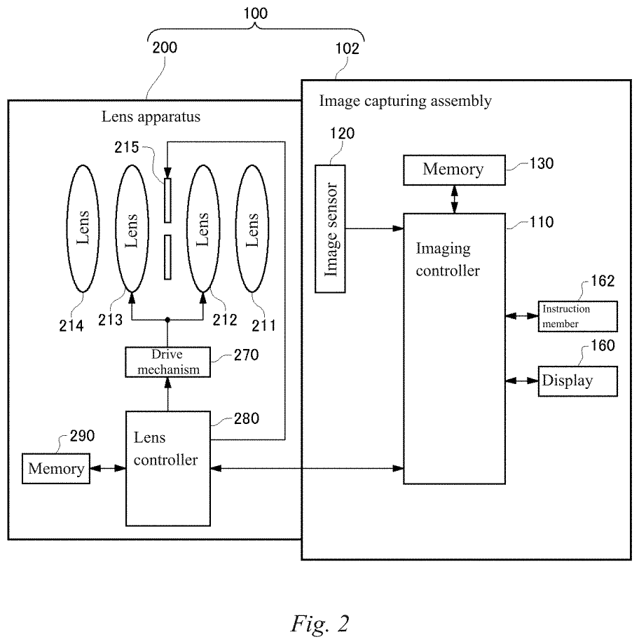

FIG. 1 is a diagram showing an example of an external perspective view of an image capturing apparatus 100 according to the present disclosure. FIG. 2 shows an example of a functional block diagram of the image capturing apparatus 100 according to the present disclosure. The image capturing apparatus 100 comprises an image capturing assembly 102 and a lens apparatus 200. The image capturing assembly 102 comprises an image sensor 120, an imaging controller 110, and a memory 130. The image sensor 120 may include a CCD or CMOS. The image sensor 120 captures an image formed through lenses. The image sensor 120 outputs image data of an optical image formed through the lenses to an imaging controller 110. The imaging controller 110 may include a microprocessor such as a CPU or an MPU, and a microcontroller such as an MCU, or the like. The memory 130 may be a computer-readable recording medium and may include at least one of flash memories such as an SRAM, a DRAM, an EPROM, an EEPROM, and a USB memory. The memory 130 stores a program or the like necessary for the imaging controller 110 to control the image sensor 120 or the like. The memory 130 may be provided inside the housing of the image capturing apparatus 100. The memory 130 may be provided so as to be removable from the housing of the image capturing apparatus 100.

The image capturing assembly 102 may further comprise an instruction member 162 and a display 160. The instruction member 162 is a user interface that receives an instruction from a user for the image capturing apparatus 100. The display 160 displays an image captured by the image sensor 120, various setting information of the image capturing apparatus 100, and the like. The display 160 may include a touch panel.

The lens apparatus 200 comprises a first lens group 211, a second lens group 212, a third lens group 213, and a fourth lens group 214. The lens apparatus 200 comprises a light amount control mechanism 215, a drive mechanism 270, and a lens controller 280. The first lens group 211, the second lens group 212, the third lens group 213, and the fourth lens group 214 may function as a single-focus lens. The first lens group 211, the second lens group 212, the third lens group 213, and the fourth lens group 214 are arranged such that they can move along an optical axis. The lens apparatus 200 may be an interchangeable lens that is detachably provided with respect to the image capturing assembly 102. The drive mechanism 270 moves at least one of the second lens group 212 and the third lens group 213 along the optical axis. The drive mechanism 270 may move the first lens group 211 or the fourth lens group 214 along the optical axis. The lens controller 280 drives the drive mechanism 270 according to a lens control command from the image capturing assembly 102, to move the second lens group 212 and the third lens group 213 along an optical axis direction. The lens control command is, for example, a focus control command. The drive mechanism 270 may comprise an electric motor, a cam ring driven by the electric motor, and a moving frame that moves in the optical axis direction together with the lenses in accordance with the rotation of the cam ring. The electric motor may be a stepping motor, a DC motor, a coreless motor, or an ultrasonic motor.

The lens apparatus 200 further comprises a memory 290. The memory 290 stores control values of the drive mechanism 270 and the lens moved by the drive mechanism 270. The memory 290 may include at least one of flash memories such as an SRAM, a DRAM, an EPROM, an EEPROM, and a USB memory.

The light amount control mechanism 215 controls the amount of light incident on the image sensor 120. The light amount control mechanism 215 comprises at least one of an diaphragm mechanism and a shutter mechanism. The light amount control mechanism 215 may include a plurality of diaphragm blades. The light amount control mechanism 215 may include an actuator. The actuator may be an electromagnetic actuator. The electromagnetic actuator may be an electromagnet, a solenoid, or a stepping motor. The light amount control mechanism 215 may receive an instruction from the lens controller 280 to drive the actuator to adjust the degree of overlap of the plurality of diaphragm blades and adjust the size of an aperture diameter.

In the image capturing apparatus 100 configured as described above, the lens apparatus 200 may be a single-focus lens capable of switching to a plurality of photographing modes. The plurality of photographing modes include a full-time MF mode in which focusing control is performed through auto focus (AF) and then through manual focus (MF), and a distance scale MF mode in which focusing control is performed through manual focus using a distance scale. The distance scale MF mode includes a mode in which the distance from a subject to be focused is in a first distance range and a mode in which the distance from a subject to be focused is in a second distance range which includes a distance shorter than the distance of the first distance range. More specifically, the distance scale MF mode includes a normal photographing mode in which the distance from a subject is in a first distance range including a distance from infinity to a first distance (for example, 0.5 m), and a macro photographing mode in which the distance from a subject is in a second distance range including a distance from the first distance (for example, 0.5 m) to a second distance (for example, 0.3 m) shorter than the first distance.

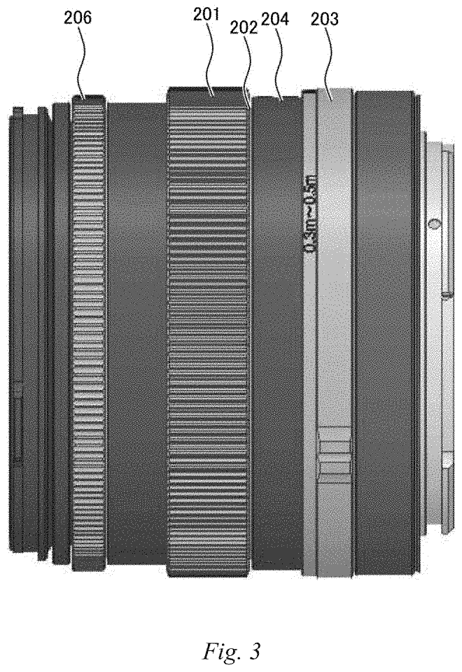

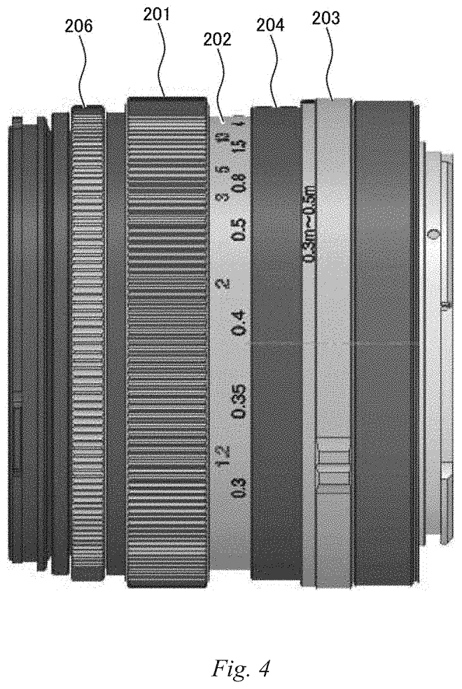

FIG. 3 shows a side view of the lens apparatus 200 set to the full-time MF mode. FIG. 4 shows a side view of the lens apparatus 200 set to the distance scale MF mode.

The lens apparatus 200 comprises an operation ring 201, a display ring 202, a switching ring 203, and a functional ring 206 that can rotate about the optical axis. The lens apparatus 200 further comprises a cover ring 204 that does not rotate about the optical axis. The operation ring 201 receives an operation of moving at least one of the second lens group 212 and the third lens group 213 in the optical axis direction to perform focusing control. The display ring 202 displays a distance scale, which shows the distance from a subject to be focused, as an indicator corresponding to a rotation angle about the optical axis. The operation ring 201 and the display ring 202 can move in the optical axis direction.

FIG. 3 shows a state in which the operation ring 201 and the display ring 202 are moved to an image plane side position in the optical axis direction. FIG. 4 shows a state in which the operation ring 201 and the display ring 202 are moved to a subject side position in the optical axis direction. The cover ring 204 covers the area showing the distance scale of the display ring 202 when the operation ring 201 and the display ring 202 are in the image plane side position in the optical axis direction. The area showing the distance scale of the display ring 202 is exposed without being covered by the cover ring 204 when the operation ring 201 and the display ring 202 are in the subject side position in the optical axis direction.

The lens apparatus 200 is set to the full-time MF mode when the operation ring 201 and the display ring 202 are in the image plane side position in the optical axis direction. The lens apparatus 200 is set to the distance scale MF mode when the operation ring 201 and the display ring 202 are in the subject side position in the optical axis direction.

The functional ring 206 receives an operation of switching the setting of various photographing conditions of the image capturing apparatus 100. For example, the functional ring 206 receives an operation of switching an F value or a shutter speed. The photographing conditions serving as targets to be switched may be selected in advance by the user.

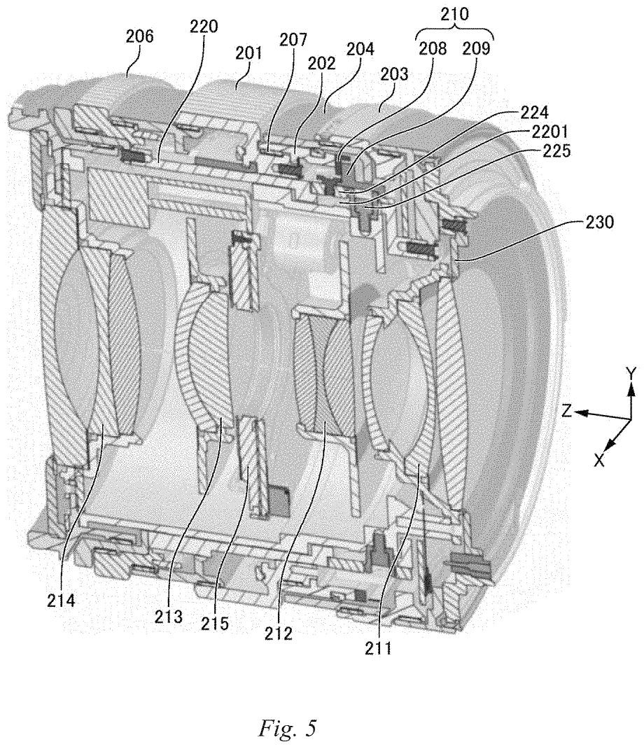

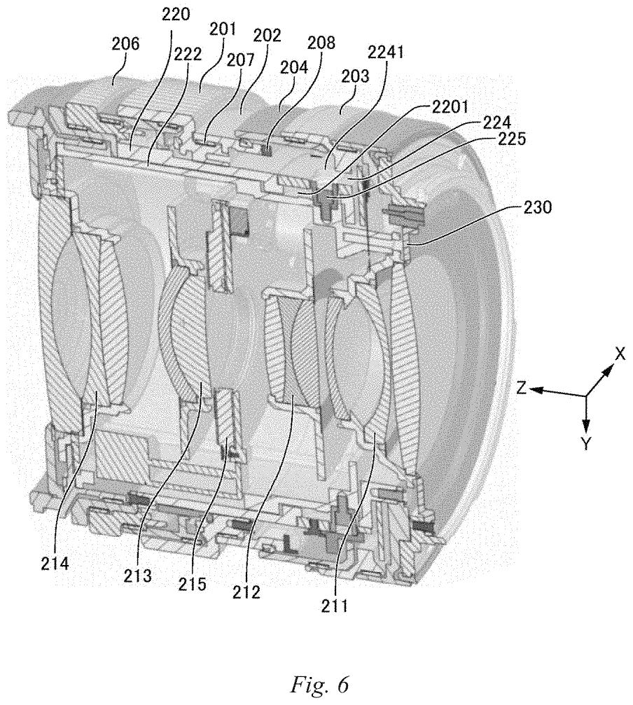

FIG. 5 is a cross-sectional perspective view of the lens apparatus 200 in a state in which the operation ring 201 and the display ring 202 are moved to the image plane side position in the optical axis direction. FIG. 6 is a cross-sectional perspective view of the lens apparatus 200 in a state in which the operation ring 201 and the display ring 202 are moved to the subject side position in the optical axis direction.

The lens apparatus 200 comprises a fixed barrel 220 that accommodates the first lens group 211, the second lens group 212, the third lens group 213, and the fourth lens group 214. The fixed barrel 220 is an example of a first barrel. The operation ring 201 is arranged around the fixed barrel 220 such that the operation ring can rotate about the optical axis. The operation ring 201 receives an operation of focus adjustment from the user. The operation ring 201 receives an operation of moving at least one of the second lens group 212 and the third lens group 213 in the optical axis direction. The display ring 202 is arranged around the fixed barrel 220 such that the display ring can rotate about the optical axis, and is arranged such that the display ring can move together with the operation ring 201 between the subject side position and the image plane side position in the optical axis direction. The lens apparatus 200 further comprises a circuit substrate 230 so as to surround the outer periphery of the fourth lens group 214.

The lens apparatus 200 further comprises a friction member 207. The friction member 207 is arranged between the respective surfaces of the operation ring 201 and the display ring 202 facing each other, and when the operation ring 201 and the display ring 202 are in the subject side position the friction member generates a frictional force on the display ring 202 that rotates the display ring 202 together with the operation ring 201 in accordance with the rotation of the operation ring 201.

The lens apparatus 200 further comprises a resistance member 210. When the operation ring 201 and the display ring 202 are in the image plane side position, the resistance member 210 generates a resistance force on the display ring 202 to prevent the display ring 202 from rotating together with the operation ring 201 in accordance with the rotation of the operation ring 201. When the operation ring 201 and the display ring 202 are in the image plane side position, the resistance member 210 holds the display ring 202 so that the display ring 202 does not rotate, as the operation ring 201 rotates, due to the frictional force of the friction member 207.

The lens apparatus 200 further comprises a rectilinear movement barrel 222 and a cam ring 224. The rectilinear movement barrel 222 holds the first lens group 211, the second lens group 212, the third lens group 213, and the fourth lens group 214. The rectilinear movement barrel 222 is arranged in the fixed barrel 220 such that the rectilinear movement barrel can move together with the first lens group 211, the second lens group 212, the third lens group 213 and the fourth lens group 214 in the optical axis direction between a normal photographing position where the photographable distance range is set to the first distance range (for example, a range from infinity to 0.5 m) and a macro photographing position where the photographable distance range is set to the second distance range (for example, a range from 0.5 m to 0.3 m).

The cam ring 224 is arranged around the fixed barrel 220 such that the cam ring can rotate about the optical axis, and comprises a cam groove 2241 (shown in FIG. 6) that engages with the cam pin 225 of the rectilinear movement barrel 222 through a rectilinear movement groove 2201 of the fixed barrel 220 along the optical axis direction.

The switching ring 203 is arranged around the cam ring 224 such that the switching ring can rotate about the optical axis together with the cam ring 224. The switching ring 203 receives an operation of switching the rectilinear movement barrel 222 between the normal photographing position and the macro photographing position by means of the cam ring 224.

As the switching ring 203 rotates about the optical axis, the cam ring 224 rotates about the optical axis. When the cam ring 224 rotates, the cam pin 225 is guided by the rectilinear movement groove 2201 and the cam groove 2241, and the rectilinear movement barrel 222 moves in the optical axis direction between the normal photographing position and the macro photographing position.

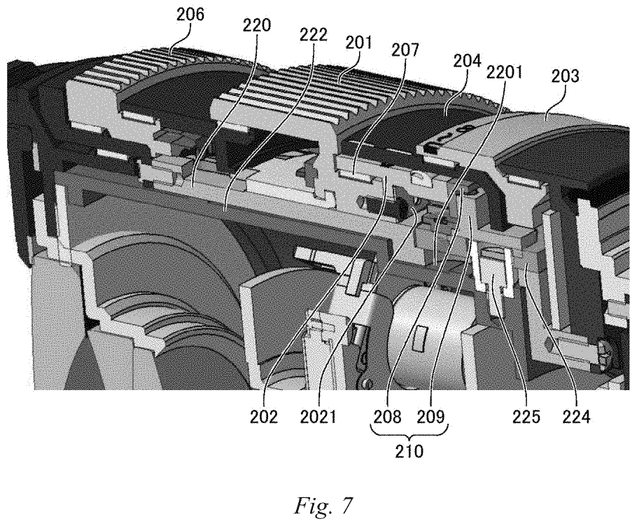

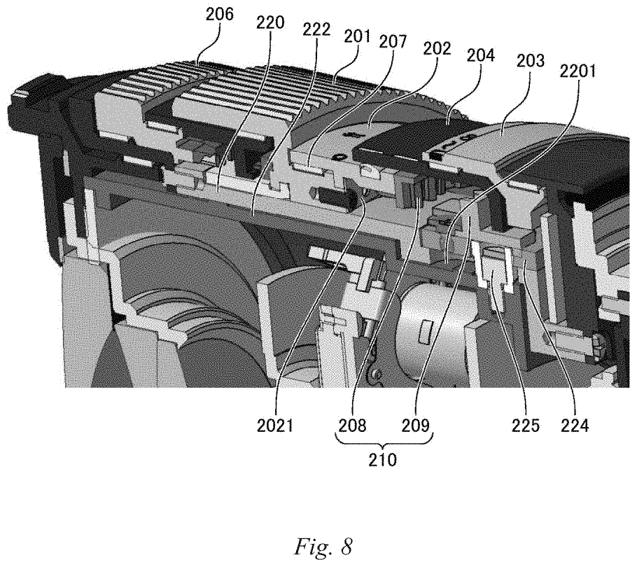

FIG. 7 is an enlarged cross-sectional perspective view of a part including the friction member 207 and the resistance member 210 when the operation ring 201 and the display ring 202 are in the image plane side position. FIG. 8 is an enlarged cross-sectional perspective view of a part including the friction member 207 and the resistance member 210 when the operation ring 201 and the display ring 202 are in the subject side position.

The display ring 202 covers part of the outer peripheral surface of the operation ring 201. The friction member 207 is arranged between part of the outer peripheral surface of the operation ring 201 and part of the inner peripheral surface of the display ring 202 facing the part of the outer peripheral surface of the operation ring 201. The display ring 202 may be pressed against the operation ring 201 side in the optical axis direction by a leaf spring 2021. The leaf spring 2021 may press a protruding portion protruding from the inner peripheral surface of the display ring 202 in the optical axis direction against the operation ring 201 side.

The friction member 207 may be adhered to part of the outer peripheral surface of the operation ring 201 with an adhesive. The friction member 207 may be suede-like artificial leather. The friction member 207 may be, for example, Ultrasuede® or Ecsaine®.

The resistance member 210 comprises a first engagement member 208 fixed to the display ring 202 and a second engagement member 209 which is held in the fixed barrel 220 and engages with the first engagement member 208 when the operation ring 201 and the display ring 202 are in the image plane side position. The first engagement member 208 comprises a plurality of first convex portions. The plurality of first convex portions are arranged at equal intervals on an image plane side surface of the display ring 202.

The second engagement member 209 is held in the fixed barrel 220 by being fixed to the cam ring 224, and engages with the first engagement member 208 when the operation ring 201 and the display ring 202 are in the image plane side position. The second engagement member 209 comprises a plurality of second convex portions that engage with the plurality of first convex portions when the operation ring 201 and the display ring 202 are in the image plane side position. The plurality of second convex portions are arranged at equal intervals on the outer peripheral surface of the cam ring 224.

When the operation ring 201 and the display ring 202 are in the subject side position, the lens controller 280 controls, on the basis of the rotation angle of the display ring 202 with respect to the fixed barrel 220, the drive mechanism 270 to move at least one of the second lens group 212 and the third lens group 213 in the optical axis direction so as to perform focusing control. When the operation ring 201 and the display ring 202 are in the image plane side position, the lens controller 280 is configured to control, on the basis of a rotation amount and rotation direction of the operation ring 201, the drive mechanism 270 to move at least one of the second lens group 212 and the third lens group 213 in the optical axis direction.

According to the lens apparatus 200 configured as described above, when in the distance scale MF mode, that is, when the operation ring 201 and the display ring 202 are in the subject side position, the display ring 202 rotates in accordance with the rotation of the operation ring 201 due to the frictional force from the friction member 207. While, when in the full-time MF mode, that is, when the operation ring 201 and the display ring 202 are in the image plane side position, the first engagement member 208 fixed to the display ring 202 and the second engagement member 209 fixed to the cam ring 224 are engaged. Accordingly, the operation ring 201 is operated with an operation torque that exceeds the frictional force from the friction member 207, so that the operation ring 201 can rotate without the rotation of the display ring 202. Therefore, the display ring 202 can maintain a photographing distance set in the distance scale MF mode even when the mode is switched from the distance scale MF mode to the full-time MF mode.

In addition, a rotation angle range in which the display ring 202 can rotate in the distance scale MF mode is physically limited to a rotation angle range corresponding to the distance scale. That is, the display ring 202 cannot rotate beyond a predetermined rotation angle range. Herein, in the distance scale MF mode, the user may attempt to rotate the operation ring 201 beyond a predetermined rotation angle range of the display ring 202. However, the display ring 202 only rotates together with the operation ring 201 due to the frictional force from the friction member 207. Therefore, when an attempt is made to rotate the operation ring 201 beyond a predetermined rotation angle range of the display ring 202 and if an operation torque that exceeds the frictional force from the friction member 207 is generated in the operation ring 201, only the operation ring 201 rotates. Accordingly, when an attempt is made to rotate the operation ring 201 beyond a predetermined rotation angle range of the display ring 202, the load generated by the first engagement member 208 of the display ring 202 and the second engagement member 209 of the cam ring 224 can be reduced. For that reason, the first engagement member 208 and the second engagement member 209 do not need to have a strong rigidity, and the first convex portions and the second convex portions can be arranged at a fine pitch. Accordingly, when the mode is switched from the distance scale MF mode to the full-time MF mode, the rotation deviation of the display ring 202 can be minimized through the engagement between the first engagement member 208 and the second engagement member 209.

A structure in which the rotation angle range in which the display ring 202 can rotate in the distance scale MF mode is physically limited to the rotation angle range with respect to the distance scale will be further explained.

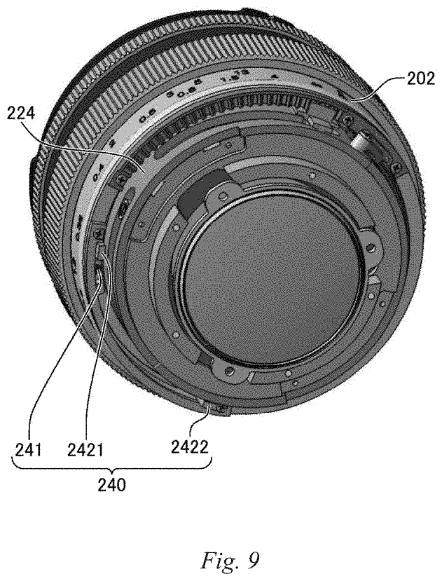

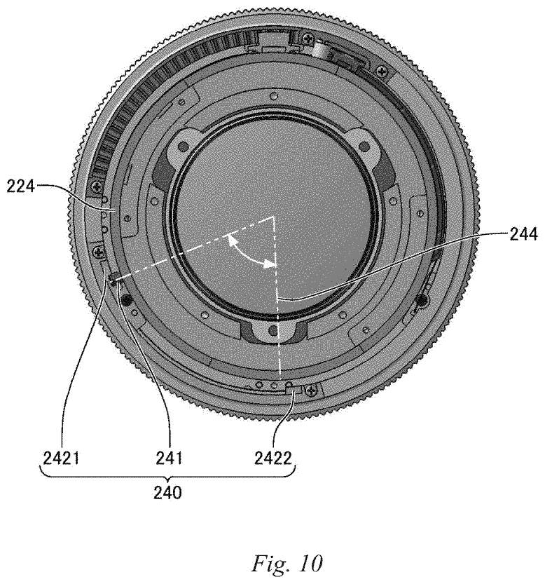

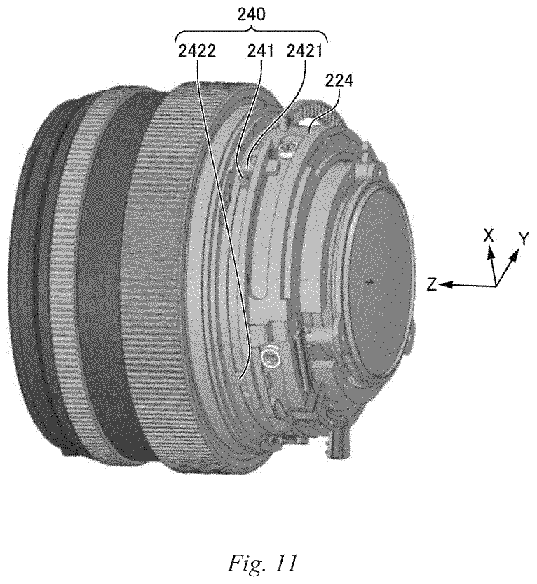

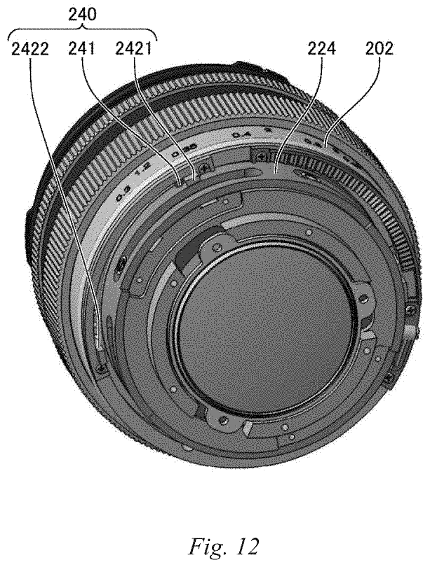

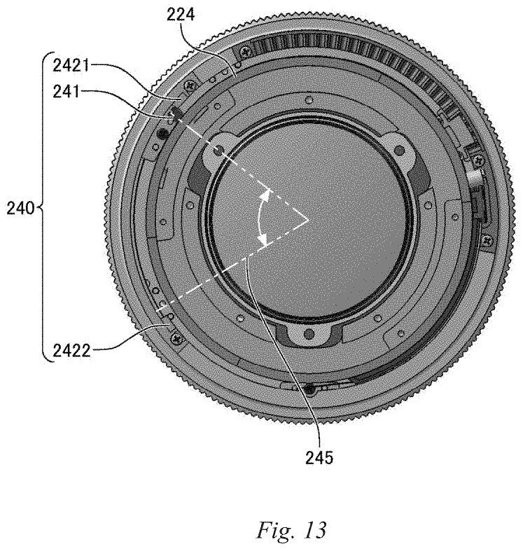

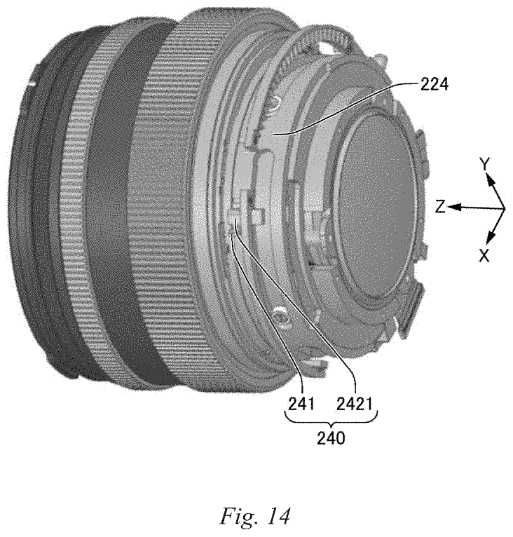

FIG. 9, FIG. 10, and FIG. 11 show the positional relationship of the rotation restraining member 240 in the normal photographing mode. FIG. 12, FIG. 13, and FIG. 14 show the positional relationship of the rotation restraining member 240 in the macro photographing mode. The rotation restraining member 240 limits the rotation of the display ring 202 to the first rotation angle range 244 when the rectilinear movement barrel 222 is in the normal photographing position. The rotation restraining member 240 limits the rotation of the display ring 202 to the second rotation angle range 245 when the rectilinear movement barrel 222 is in the macro photographing mode.

The rotation restraining member 240 comprises a first restraining member 241 provided on the cam ring 224 and second restraining members 2421 and 2422 provided on the display ring 202. The rotation of the display ring 202 is limited to the first rotation angle range 244 or the second rotation angle range 245 through the restraint of the second restraining members 2421 and 2422 by the first restraining member 241.

The first restraining member 241 is provided on the outer peripheral surface of the cam ring 224. The first restraining member 241 may be a pin protruding from the outer peripheral surface of the cam ring 224. The second restraining members 2421 and 2422 may be convex portions or concave portions provided on the image plane side surface of the display ring 202. The second restraining member 2421 contacts the first restraining member 241 at one boundary of the first rotation angle range 244 or at one boundary of the second rotation angle range 245 to limit the rotation of the display ring 202. The second restricting portion 2422 contacts the first restricting portion 241 at the other boundary of the first rotation angle range 244 or at the other boundary of the second rotation angle range 245 to limit the rotation of the display ring 202.

The first restraining member 241 is fixed to the cam ring 224. The cam ring 224 rotates, in response to the switching between the normal photographing mode and the macro photographing mode, together with the switching ring 203 as the switching ring 203 rotates. Therefore, the position of the first restraining member 241 changes with respect to the fixed barrel 220 in the normal photographing mode and the macro photographing mode. For that reason, the position of the rotation angle range that limits the rotation of the display ring 202 changes in the normal photographing mode and the macro photographing mode.

A rotation restraining member 240 is provided on the cam ring 224 and the display ring 202. Accordingly, even in the full-time MF mode, when the switching ring 203 is rotated, the cam ring 224 rotates, and the switching between the normal photographing mode and the macro photographing mode is performed. That is, the rectilinear movement barrel 222 is switched between the normal photographing position and the macro photographing position. Moreover, in response to the rotation of the cam ring 224, the position of the first restraining member 241 changes and a rotation angle range of the display ring 202 is switched between the first rotation angle range 244 and the second rotation angle range 245.

The lens apparatus 200 comprises a photo interrupter for measuring the rotation amount and rotation direction of the operation ring 201. In addition, the lens apparatus 200 further comprises a potentiometer for measuring the rotation angle of the display ring 202. In the full-time MF mode, the lens controller 280 controls, on the basis of the rotation amount and rotation direction of the operation ring 201 measured by the photo interrupter, the drive mechanism 270 to move at least one of the second lens group 212 and the third lens group 213 in the optical axis direction, so as to perform focusing control. In the distance scale MF mode, the lens controller 280 controls, on the basis of the rotation angle of the display ring 202 with respect to the fixed barrel 220, the drive mechanism 270 to move at least one of the second lens group 212 and the third lens group 213 in the optical axis direction, so as to perform focusing control.

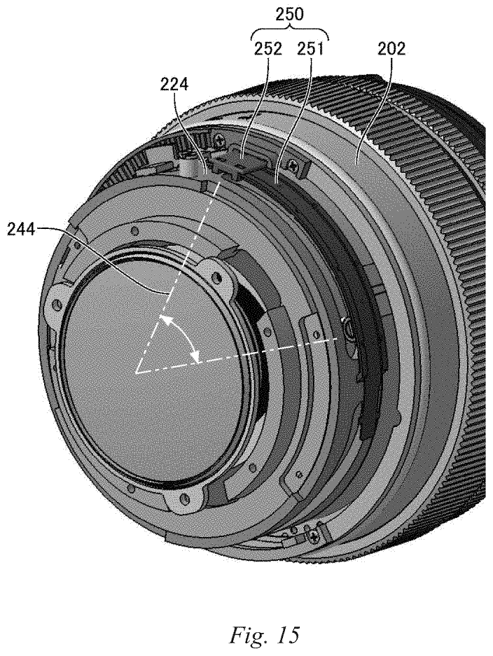

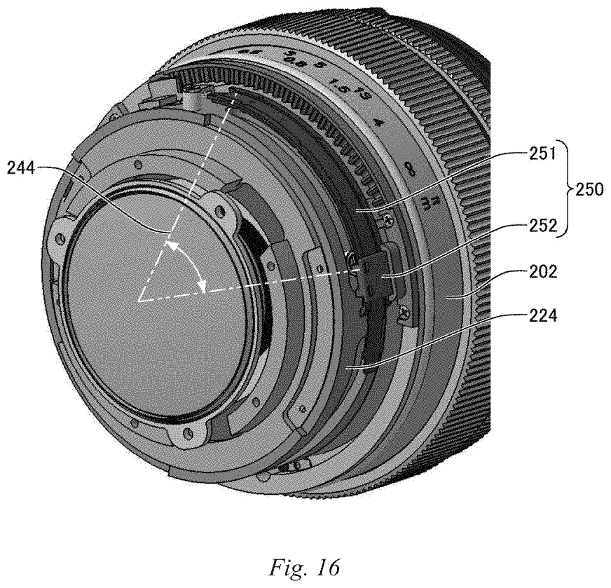

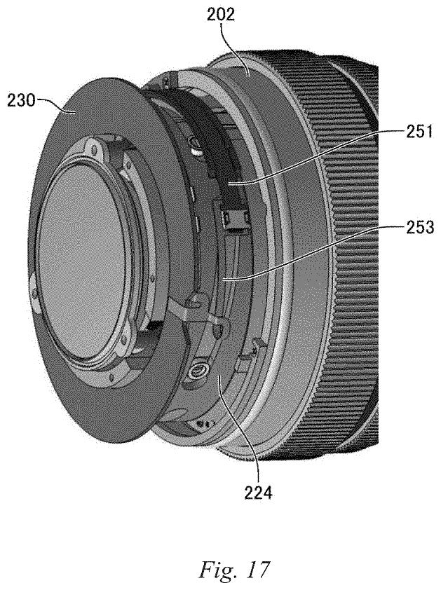

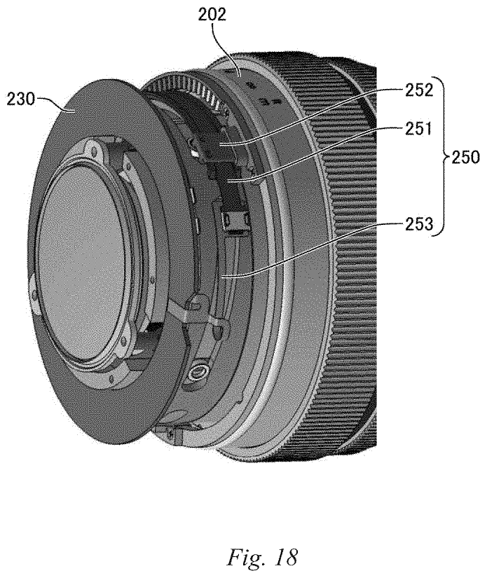

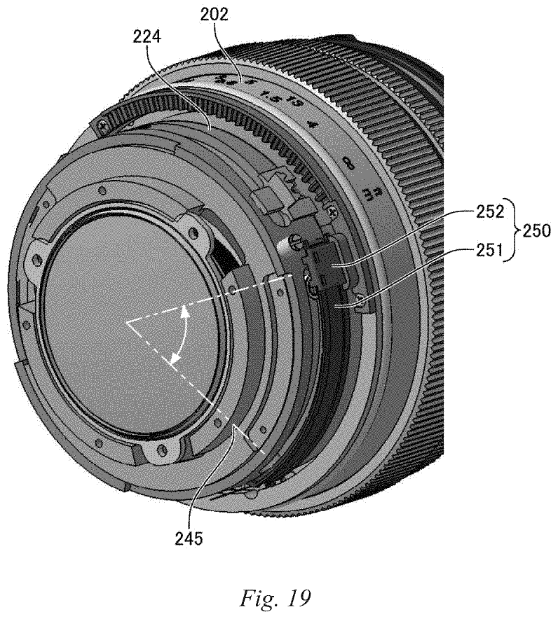

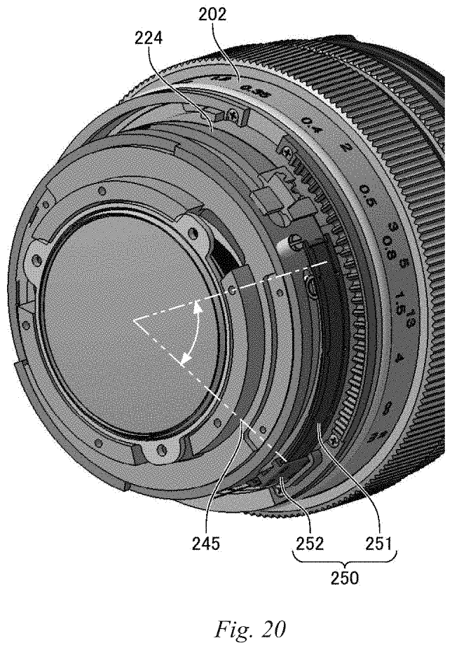

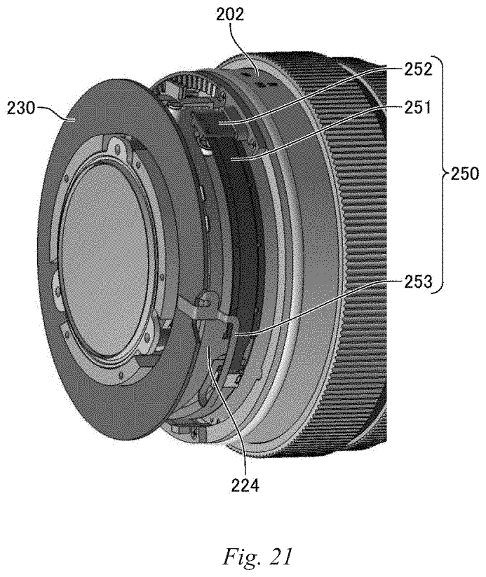

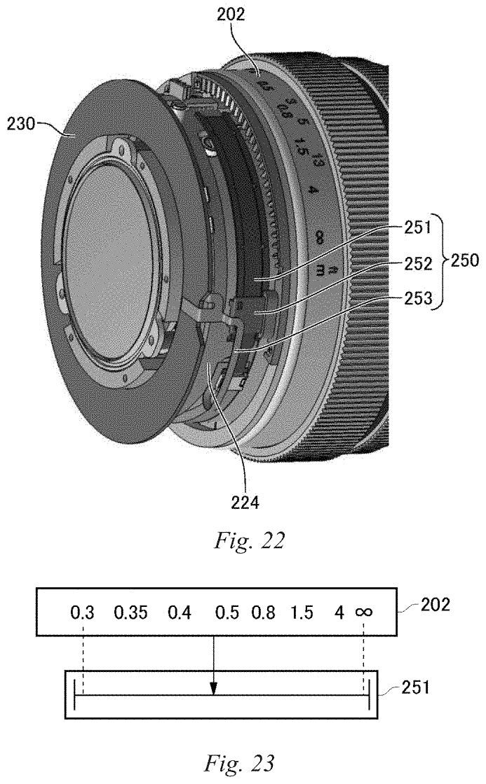

FIG. 15, FIG. 16, FIG. 17, and FIG. 18 show the positional relationship of a potentiometer 250 in the normal photographing mode. FIG. 19, FIG. 20, FIG. 21, and FIG. 22 show the positional relationship of the potentiometer 250 in the macro photographing mode.

The potentiometer 250 includes a resistor 251 and a wiper 252. The resistor 251 is provided on the outer peripheral surface of the cam ring 224 in a circular arc shape. The wiper 252 is provided on the display ring 202 and slides on the resistor 251 while being in contact with the resistor 251. The potentiometer 250 measures the rotation angle of the display ring 202 with respect to the cam ring 224 according to the potential of the wiper 252.

The potentiometer 250 further includes a flexible printed circuit substrate 253. One end of the flexible printed circuit substrate 253 is electrically connected to one end of the resistor 251. The other end of the flexible printed circuit substrate 253 is electrically connected to the circuit substrate 230. Since the resistor 251 is electrically connected to the circuit substrate 230 by means of the flexible printed circuit substrate 253, the resistor 251 can rotate about the optical axis together with the cam ring 224 in a state of being electrically connected to the circuit substrate 230.

The resistor 251 moves with respect to the fixed barrel 220 according to the rotation of the cam ring 224. In the normal photographing mode, the potentiometer 250 only needs to be able to measure the rotation angle of the display ring 202 with respect to the cam ring 224 in the first rotation angle range 244 in which the display ring 202 rotates. While, in the macro photographing mode, the potentiometer 250 only needs to be able to measure the rotation angle of the display ring 202 with respect to the cam ring 224 in the second rotation angle range 245 in which the display ring 202 rotates. Therefore, the circular arc length of the resistor 251 may be shorter than the circular arc length of the area where the distance scale, which is an indicator of the display ring 202, is displayed.

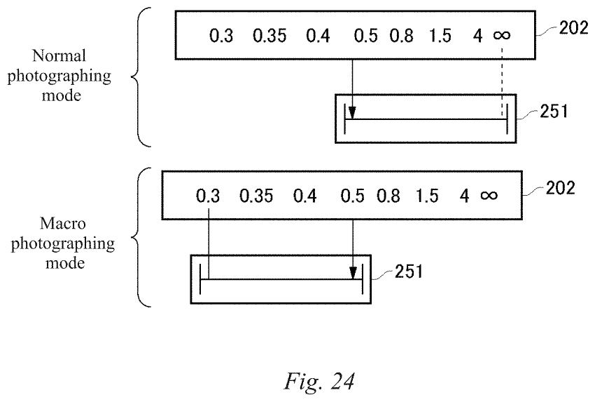

As shown in FIG. 23, it is conceivable that the circular arc length of the resistor 251 may be longer than the circular arc length of the area of the distance scale of the display ring 202 or the same length as the circular arc length of the area of the distance scale of the display ring 202. However, when the circular arc length of the resistor 251 becomes longer, the measurement accuracy may be decreased due to the relationship between the voltage that can be applied to the resistor 251 and the noise. While, as shown in FIG. 24, in some embodiments, the resistor 251 moves with respect to the area of the distance scale of the display ring 202 in the normal photographing mode and the macro photographing mode. Therefore, the circular arc length of the resistor 251 may be shorter than the circular arc length of the area where the distance scale, which is an indicator of the display ring 202, is displayed. Since the circular arc length of the resistor 251 becomes shorter, it is possible to prevent a decrease in measurement accuracy.

The size of the first rotation angle range 244 in which the display ring 202 can rotate in the normal photographing mode and the size of the second rotation angle range 245 in which the display ring 202 can rotate in the macro photographing mode are the same. Therefore, the circular arc length of the resistor 251 may be half the circular arc length of the area where the distance scale, which is an indicator of the display ring 202, is displayed.

Since the resistor 251 moves with respect to the fixed barrel 220, the lens controller 280 cannot specify the rotation angle of the display ring 202 with respect to the fixed barrel 220 only from the measurement result of the potentiometer 250. So the lens controller 280 controls, on the basis of the rotation position of the switching ring 203 with respect to the fixed barrel 220 and the rotation angle of the display ring 202 measured by the potentiometer 250, the drive mechanism 270 to move at least one of the second lens group 212 and the third lens group 213 in the optical axis direction, so as to perform focusing control.

The lens apparatus 200 comprises a photo interrupter that detects the rotation of the switching ring 203. On the basis of the detection result of the photo interrupter, the lens controller 280 determines whether the switching ring 203 is in the rotation position corresponding to the normal photographing mode or the rotation position corresponding to the macro photographing mode. The lens controller 280 may specify the rotation angle of the display ring 202 with respect to the fixed barrel 220 on the basis of the determination result of whether the switching ring 203 is in the rotation position corresponding to the normal photographing mode or the rotation position corresponding to the macro photographing mode, and the rotation angle of the display ring 202 measured by the potentiometer 250. The lens controller 280 may control, on the basis of the specified rotation angle of the display ring 202 with respect to the fixed barrel 220, the drive mechanism 270 to move at least one of the second lens group 212 and the third lens group 213 in the optical axis direction, so as to perform focusing control.

Although the present disclosure has been explained using the embodiments, the technical scope of the present disclosure is not limited to the scope described in the above embodiments. It will be apparent to a person skilled in the art that various modifications or improvements can be made with regard to the above embodiments. It is apparent that embodiments with such modifications or improvements can be included in the technical scope of the present disclosure.

It should be noted that the order of carrying out each instance of processing, such as an operation, procedure, step, and stage in an apparatus, system, program, and method shown in claims, description, and drawings may be implemented in any order unless otherwise indicated by “before” and “prior,” etc., and that the output of the previous instance of processing is not used in subsequent processing. Operation flows in claims, description, and drawings are described using “first,” “next,” and the like for the sake of convenience, but it does not mean that the flows are necessarily to be performed in this order.

### DESCRIPTION OF THE REFERENCE NUMERALS

100 Image capturing apparatus
102 Image capturing assembly
110 Imaging controller
120 Image sensor
130 Memory
160 Display
162 Instruction member
200 Lens apparatus
201 Operation ring
202 Display ring
203 Switching ring
204 Cover ring
206 Functional ring
207 Friction member
208 First engagement member
209 Second engagement member
210 Resistance member
211 First lens group
212 Second lens group
213 Third lens group
214 Fourth lens group
215 Light amount control mechanism
220 Fixed barrel
222 Rectilinear movement barrel
224 Cam ring
225 Cam pin
230 Circuit substrate
240 Rotation restraining member
241 First restraining member
244 First rotation angle range
245 Second rotation angle range
250 Potentiometer
251 Resistor
252 Wiper
253 Flexible printed circuit substrate
270 Drive mechanism
280 Lens controller
290 Memory
2021 Leaf spring
2201 Rectilinear movement groove
2241 Cam groove
2421, 2422 Second restraining member

What is claimed is:

1. A lens apparatus comprising
a barrel configured to accommodate a plurality of lenses;
a first ring arranged around the barrel and configured to rotate about an optical axis;
a second ring arranged around the first barrel and configured to rotate about the optical axis and move together with the first ring between a first position and a second position in an optical axis direction along the optical axis;
a friction member arranged between a first surface of the first ring and a second surface of the second ring facing each other, and configured to generate a frictional force on the second ring to cause the second ring to rotate together with the first ring when the first ring and the second ring are in the first position; and
a resistance member configured to generate a resistance force on the second ring to prevent the second ring from rotating together with the first ring when the first ring and the second ring are in the second position.

2. The lens apparatus according to claim 1, wherein the resistance member includes:
a first engagement member fixed to the second ring; and
a second engagement member held in the barrel and configured to engage with the first engagement member when the first ring and the second ring are in the second position.

3. The lens apparatus according to claim 2, wherein the first engagement member includes a plurality of first convex portions and the second engagement member includes a plurality of second convex portions configured to engage with the plurality of first convex portions.

4. The lens apparatus according to claim 3, wherein:
the second ring covers a part of an outer peripheral surface of the first ring; and
the friction member is arranged between the part of the outer peripheral surface of the first ring and a part of an inner peripheral surface of the second ring facing the part of the outer peripheral surface of the first ring.

5. The lens apparatus according to claim 4, wherein:
the first ring includes an operation ring configured to receive an operation of moving at least one of the plurality of lenses in the optical axis direction; and
the second ring includes a display ring configured to display an indicator corresponding to a rotation angle with respect to the barrel.

6. The lens apparatus according to claim 2, wherein:
the second ring covers a part of an outer peripheral surface of the first ring; and
the friction member is arranged between the part of the outer peripheral surface of the first ring and a part of an inner peripheral surface of the second ring facing the part of the outer peripheral surface of the first ring.

7. The lens apparatus according to claim 6, wherein:
the first ring includes an operation ring configured to receive an operation of moving at least one of the plurality of lenses in the optical axis direction; and
the second ring includes a display ring configured to display an indicator corresponding to a rotation angle with respect to the barrel.

8. The lens apparatus according to claim 7, further comprising:
a circuit configured to:
control, based on the rotation angle of the display ring with respect to the barrel, a drive mechanism to move the at least one of the plurality of lenses in the optical axis direction when the operation ring and the display ring are in the first position; and
control, based on a rotation amount and a rotation direction of the operation ring, the drive mechanism to move the at least one of the plurality of lenses in the optical axis direction when the operation ring and the display ring are in the second position.

9. The lens apparatus according to claim 7,
wherein the barrel is a first barrel;
the lens apparatus further comprising:
a second barrel arranged in the first barrel and configured to:
hold the plurality of lenses; and
move in the optical axis direction together with the plurality of lenses between a third position where a photographable distance range is set to a first distance range and a fourth position where the photographable distance range is set to a second distance range;
a cam ring arranged around the first barrel and configured to rotate about the optical axis, the cam ring including a cam groove configured to engage with a cam pin of the second barrel through a groove of the first barrel along the optical axis direction; and
a switching ring arranged around the cam ring and configured to rotate about the optical axis together with the cam ring to switch the second barrel between the third position and the fourth position.

10. The lens apparatus according to claim 9, wherein the resistance member includes:
a first engagement member fixed to the display ring; and
a second engagement member held in the first barrel by being fixed to the cam ring, and configured to engage with the first engagement member when the operation ring and the display ring are in the second position.

11. The lens apparatus according to claim 10, wherein the first engagement member includes a plurality of first convex portions and the second engagement member includes a plurality of second convex portions configured to engage with the plurality of first convex portions.

12. The lens apparatus according to claim 7, further comprising:
a cover ring arranged around the first barrel and configured to, when the operation ring and the display ring are in the second position, cover an outer peripheral surface of the display ring for displaying the indicator.

13. The lens apparatus according to claim 1, wherein:
the second ring covers a part of an outer peripheral surface of the first ring; and
the friction member is arranged between the part of the outer peripheral surface of the first ring and a part of an inner peripheral surface of the second ring facing the part of the outer peripheral surface of the first ring.

14. The lens apparatus according to claim 13, wherein:
the first ring includes an operation ring configured to receive an operation of moving at least one of the plurality of lenses in the optical axis direction; and
the second ring includes a display ring configured to display an indicator corresponding to a rotation angle with respect to the barrel.

15. The lens apparatus according to claim 14, further comprising:
a circuit configured to:
control, based on the rotation angle of the display ring with respect to the barrel, a drive mechanism to move the at least one of the plurality of lenses in the optical axis direction when the operation ring and the display ring are in the first position; and
control, based on a rotation amount and a rotation direction of the operation ring, the drive mechanism to move the at least one of the plurality of lenses in the optical axis direction when the operation ring and the display ring are in the second position.

16. The lens apparatus according to claim 14,
wherein the barrel is a first barrel;
the lens apparatus further comprising:
a second barrel arranged in the first barrel and configured to:
hold the plurality of lenses; and
move in the optical axis direction together with the plurality of lenses between a third position where a photographable distance range is set to a first distance range and a fourth position where the photographable distance range is set to a second distance range;
a cam ring arranged around the first barrel and configured to rotate about the optical axis, the cam ring including a cam groove configured to engage with a cam pin of the second barrel through a groove of the first barrel along the optical axis direction; and
a switching ring arranged around the cam ring and configured to rotate about the optical axis together with the cam ring to switch the second barrel between the third position and the fourth position.

17. The lens apparatus according to claim 16, wherein the resistance member includes:
a first engagement member fixed to the display ring; and
a second engagement member held in the first barrel by being fixed to the cam ring, and configured to engage with the first engagement member when the operation ring and the display ring are in the second position.

18. The lens apparatus according to claim 17, wherein the first engagement member includes a plurality of first convex portions and the second engagement member includes a plurality of second convex portions configured to engage with the plurality of first convex portions.

19. The lens apparatus according to claim 14, further comprising:
a cover ring arranged around the first barrel and configured to, when the operation ring and the display ring are in the second position, cover an outer peripheral surface of the display ring for displaying the indicator.

20. An image capturing apparatus comprising:
a lens apparatus including:
a barrel configured to accommodate a plurality of lenses;
a first ring arranged around the barrel and configured to rotate about an optical axis;
a second ring arranged around the first barrel and configured to rotate about the optical axis and move together with the first ring between a first position and a second position in an optical axis direction along the optical axis;
a friction member arranged between a first surface of the first ring and a second surface of the second ring facing each other, and configured to generate a frictional force on the second ring to cause the second ring to rotate together with the first ring when the first ring and the second ring are in the first position; and
a resistance member configured to generate a resistance force on the second ring to prevent the second ring from rotating together with the first ring when the first ring and the second ring are in the second position; and
an image sensor configured to capture an image formed through the plurality of lenses.
